(19) United States
(12) Patent Application Publication
(10) Pub. No.: US 2007/0161376 A1
(43) Pub. Date: Jul. 12, 2007

(54) Timeslot reuse for a service based interference control

(75) Inventors: Jarri Hulkkonen, Oulu (FI); Olli Piirainen, Oulu (FI); Kari Niemela, Oulu (FI); Mikko Saily, Sipoo (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/652,403

(22) Filed: Jan. 10, 2007

Related U.S. Application Data
(60) Provisional application No. 60/758,381, filed on Jan. 11, 2006.

(51) Int. Cl. H04Q 7/20

(52) U.S. Cl. 455/447

(57) ABSTRACT

The specification and drawings present a new method, system, apparatus and software product for a timeslot (TSL) reuse typically combined with a frequency reuse for a service based interference control in communication systems. TSL reuse method can be applied to a service with a wider spectrum or a higher symbol rate than for a normal channel bandwidth of a communication system to provide the way for controlling interference. The TSL reuse method can enable interference control for synchronized and unsynchronized networks in uplink (UL) or downlink (DL).

### PRIORITY AND CROSS-REFERENCE TO RELATED APPLICATION

This application claims priority from U.S. Provisional Patent Application Ser. No. 60/758,381, filed on Jan. 11, 2006.

### TECHNICAL FIELD

This invention generally relates to communications and more specifically to time timeslot reuse for an interference control in mobile/wireless communication systems.

### BACKGROUND ART

EDGE (enhanced data rates for global evolution) further evolution candidates have been presented in GERAN (GSM (global system for mobile communications)/EDGE radio access network) 3GPP (3d generation partnership project). Dual Symbol Rate (DSR) for uplink performance improvement is proposed. As shown in 3GPP contributions, e.g., in GP-05261, Agenda Item 7.1.5.5, “Updates for Dual Symbol Rate Section of the Feasibility Study on Future GERAN Evolution”, 3GPP TSG GERAN#27, Atlanta, USA. In the DSR, the symbol rate of the GSM/EDGE is doubled and the transmitter signal is allowed to overlap adjacent carriers. The DSR nearly doubles UL (uplink) data spectral efficiency and is, therefore, the most interesting UL capacity enhancement feature for the EDGE evolution. From the system performance point of view, frequency planning needs to be considered carefully because adjacent DSR carriers are partially overlapping, which “brakes” the basic frequency planning that is made for the normal 200 kHz carriers because the DSR carriers have spectrum of approximately 600 kHz wide compared to the normal 200 kHz wide carriers as shown in FIG. 1.

Also in the case of EGPRS (enhanced general packet radio service), interference conditions need to be considered when data connections are allocated to the hopping layer. Data connections are typically causing more interference than speech connections (e.g., because data uses higher transmitter powers since C/I (carrier-to-interference ratio) and the target is higher compared to AFS (adaptive multi-rate full rate speech).

As shown in FIG. 1, the DSR carrier overlaps with adjacent carriers so that the interference situation is worse in the network using DSR; then the original frequency reuse is blurred in the DSR case. As adjacent DSR carriers are overlapping, usage of DSR makes the interference situation uncontrolled when basic frequency planning is used. In the case of tight frequency reuses of DSR carriers, e.g. with a ratio 1/3, interference is randomly received from every cell in a network of cells 11, and in case of the cell 10 under consideration in the middle of the network of cells 11 even from the closest cells in antenna main direction, as shown in FIG. 3 (numbers 0, 1, . . . , 5 in the cells indicate allocated DSR frequencies (e.g., having normal 200 kHz frequency offset) in the corresponding cells). Controlled co-channel interference with basic GSM/EDGE carriers is plotted in FIG. 2 for comparison (numbers 0, 1, . . . 5 in the cells indicate allocated normal GSM/EDGE frequencies in the corresponding cells), wherein the co-channel interference from the closest surrounding cells to the cell 1Oa under consideration in the middle of the network of cells 11a is avoided. This increased and uncontrolled UL interference affects not only the DSR itself but also other services like basic speech when voice and data are using the same frequencies.

Moreover, in the case of the EGPRS, increased interference from data connections can be a problem, data traffic is allocated to hopping layer which was originally planned for the speech traffic only. Increased interference decreases speech traffic performance.

In the GSM system, co-channel and adjacent channel interference is controlled with the frequency planning. Data and speech traffic can be separated for different frequencies so that speech and data are not interfering each other. Data traffic can be allocated to BCCH (broadcast control channel) frequencies as far as there are enough resources in a BCCH TRX (transceiver). But, when the BCCH TRX capacity is not enough for the data transmission, a certain amount of hopping layer resources need to be reserved for data. In that case, speech and data connections are interfering with each other. The EGPRS power control is one way to control the interference caused by the data traffic, but then the trade-off between the data throughput and the speech quality is made.

For the DSR concept proposed for the EDGE evolution in 3GPP there are no specific solutions available to control interference caused by wider DSR carriers. As stated in the DSR feasibility study (see GP-052610 quoted above), the current solution is to use IRC (interference rejection combining) receivers and try to cope with increased interference in the network. Also, advanced channel allocation methods which allocate channels based on interference conditions could be used, like proposed in the invention “Radio channel allocation and link adaptation in cellular telecommunication system” by Jari Hulkkonen and Olli Piirainen, filed as a Finnish patent application No. 20055687 on Dec. 21, 2005, but those require more complex allocation algorithms, interference evaluation, etc.

### DISCLOSURE OF THE INVENTION

According to a first aspect of the invention, a method, comprises: providing a frequency reuse with a ratio 1/N for communications between mobile stations which selected corresponding cells and network elements serving the corresponding cells in a communication system, N being an integer of at least a value of one; and further providing a timeslot reuse with a factor K for the communications, K being an integer of at least a value of two.

According further to the first aspect of the invention, the timeslot reuse may be provided only for selected services out of predetermined services which support the communication system. Still further, the frequency reuse may be provided for the all predetermined services.

Further according to the first aspect of the invention, the timeslot reuse may be provided only for a data service or only for a packet switched service.

Still further according to the first aspect of the invention, the frequency reuse may be provided for both a circuit switched speech service and for a packet switched data service and wherein the timeslot reuse may be provided for the circuit switched speech service only.

According yet further to the first aspect of the invention, the timeslot reuse may be provided for services comprising at least one of the following characteristics: unequal bandwidths, and unequal modulation frequencies.

According still further to the first aspect of the invention, the timeslot reuse may be provided for at least one of the following services: a) a dual symbol rate service, b) an enhanced general packet radio service, c) a service with a wider spectrum than a normal channel bandwidth, and d) a service with a higher symbol rate than for a normal channel bandwidth.

According further still to the first aspect of the invention, the timeslot reuse may be a cell timeslot reuse or a site timeslot reuse.

According yet further still to the first aspect of the invention, the communication between the mobile stations and the network elements may be performed within unsynchronized networks.

Yet still further according to the first aspect of the invention, the communications between the mobile stations and the network elements may be performed within evolved global system for mobile communications/enhances data rates for global evolution radio access network.

Still yet further according to the first aspect of the invention, the communications between the mobile stations and the network elements may be performed in an uplink.

Still further still according to the first aspect of the invention, the communication between the mobile stations and the network elements may be performed within time division multiple access based networks.

Still yet further still according to the first aspect of the invention, the network element may be a base transceiver station configured for wireless communications.

According to a second aspect of the invention, a computer program product comprises: a computer readable storage structure embodying computer program code thereon for execution by a computer processor with the computer program code, wherein the computer program code comprises instructions for performing the first aspect of the invention, indicated as being performed by any component or a combination of components of the communication system.

According to a third aspect of the invention, a network element, comprises: a reuse scheduling block, for providing to a mobile station reuse instructions comprising a frequency and a timeslot for communicating between the mobile station and the network element in a communication system, wherein the frequency is defined using a frequency reuse with a ratio 1/N for communications between mobile stations which selected corresponding cells and network elements serving the corresponding cells in the communication system, N being an integer of at least a value of one, and the timeslot is defined using a timeslot reuse with a factor K for the communications, K being an integer of at least a value of two, and wherein the timeslot reuse is provided only for selected services out of predetermined services which support the communication system; and a signal generating and transmitting module, for the communicating with the mobile station.

According further to the third aspect of the invention, the signal generating and transmitting module may be for transmitting the reuse instructions to the mobile station.

Further according to the third aspect of the invention, the timeslot reuse may improve interference control in the communication system. Still further, the timeslot reuse may be provided only for selected services out of predetermined services which support the communication system.

Still further according to the third aspect of the invention, the frequency reuse may be provided for the all predetermined services.

According yet further to the third aspect of the invention, the timeslot reuse may be provided only for a data service or only for a packet switched service.

According still further to the third aspect of the invention, the frequency reuse may be provided for both a circuit switched speech service and for a packet switched data service and wherein the timeslot reuse may be provided for the circuit switched speech service only.

According yet further still to the third aspect of the invention, the timeslot reuse may be provided for the services comprising at least one of the following characteristics: unequal bandwidths, and unequal modulation frequencies.

According further still to the third aspect of the invention, the timeslot reuse may be provided for at least one of the following services: a) a dual symbol rate service, b) an enhanced general packet radio service, c) a service with a wider spectrum than a normal channel bandwidth, and d) a service with a higher symbol rate than for a normal channel bandwidth.

Yet still further according to the third aspect of the invention, the communicating between the mobile station and the network element may be performed in an uplink.

Still yet further according to the third aspect of the invention, the timeslot reuse may be a cell timeslot reuse or a site timeslot reuse.

Still further still according to the third aspect of the invention, the communicating between the mobile station and the network element may be performed within time division multiple access based networks.

Still yet further still according to the third aspect of the invention, the communicating between the mobile station and the network element may be performed within unsynchronized networks and the reuse scheduling block may be responsive to an uplink signal comprising data or voice information.

According to a fourth aspect of the invention, a communication system, comprises: mobile stations which selected corresponding cells; and network elements serving the corresponding cells, for providing to the mobile stations reuse instructions comprising corresponding frequencies and timeslots for communications between the corresponding mobile stations and the network elements, wherein the corresponding frequencies are defined using a frequency reuse with a ratio 1/N applied to the communications, N being an integer of at least a value of one, and the timeslots are defined using a timeslot reuse with a factor K for the communications, K being an integer of at least a value of two.

Further according to the fourth aspect of the invention, the timeslot reuse may be provided only for one of: a) a data service, b) a packet switched service, and c) selected services out of predetermined services which support the communication system.

Still further according to the fourth aspect of the invention, the timeslot reuse may be provided for at least one of the following services: a) a dual symbol rate service, b) an enhanced general packet radio service, c) a service with a wider spectrum than a normal channel bandwidth, and d) a service with a higher symbol rate than for a normal channel bandwidth.

According to a fifth aspect of the invention, a mobile station, comprises: an uplink scheduling and signal generating module, responsive to reuse instructions comprising a frequency and a timeslot for communicating between the mobile station and a network element in a communication system, wherein the frequency is defined using a frequency reuse with a ratio 1/N for communications between mobile stations which selected corresponding cells and network elements serving the corresponding cells in the communication system, N being an integer of at least a value of one, and the timeslot is defined using a timeslot reuse with a factor K for the communications, K being an integer of at least a value of two out of predetermined services which support the communication system; and a transmitter/receiver processing module, for receiving a reuse instruction signal comprising the reuse instructions and for providing the reuse instructions signal to the uplink scheduling and signal generating module, and for providing the communicating between the network element and the mobile station.

According further to the fifth aspect of the invention, the timeslot reuse may improve interference control in the communication system.

Further according to the fifth aspect of the invention, the timeslot reuse may be provided only for selected services out of predetermined services which support the communication system.

According to a sixth aspect of the invention, a network element, comprises: scheduling means, for providing to a mobile station reuse instructions comprising a frequency and a timeslot for communicating between the mobile station and the network element in a communication system, wherein the frequency is defined using a frequency reuse with a ratio 1/N for communications between mobile stations which selected corresponding cells and network elements serving the corresponding cells in the communication system, N being an integer of at least a value of one, and the timeslot is defined using a timeslot reuse with a factor K for the communications, K being an integer of at least a value of two; and receiving and generating means, for communicating with the mobile station.

According further to the sixth aspect of the invention, the scheduling means may be a reuse and scheduling block, and the receiving and generating means may be a signal generating and transmitting module.

### BRIEF DESCRIPTION OF THE DRAWINGS

For a better understanding of various embodiments of the present invention, reference is made to the following detailed description taken in conjunction with the following drawings, in which:

FIG. 1 is a schematic representation of a spectrum of Dual Symbol Rate;

FIG. 2 is a schematic representation of interfering cells for a 1/3 frequency reuse with 200 kHz wide carriers;

FIG. 3 is a schematic representation of interfering cells for a 1/3 frequency reuse with approximately 600 kHz wide DSR carriers.

FIG. 4 is a schematic representation of (E)GPRS data territory without timeslot reuse;

FIG. 5 is a schematic representation of data territory with a combined frequency and TSL reuse for DSR, according to an embodiment of the present invention;

FIG. 6 is a schematic representation of cells with TSL cell reuse factor of 3 combined with 1/3 frequency reuse, according to an embodiment of the present invention;

FIG. 7 is a schematic representation of interference conditions for cells with TSL cell reuse factor of 3 combined with 1/3 frequency reuse, according to an embodiment of the present invention, according to an embodiment of the present invention;

FIG. 8 is a schematic representation of cells with TSL site reuse factor of 4 combined with 1/3 frequency reuse, according to an embodiment of the present invention;

FIG. 9 is a schematic representation of interference conditions for cells with TSL site reuse factor of 4 combined with 1/3 frequency reuse, according to an embodiment of the present invention; FIGS. 10a and 10b are graphs of interference distributions for TSL cell reuse factor of 3 and TSL site reuse factor of 4 vs. a reference case without TSL reuse for co-channel interference (FIG. 10a) and for adjacent interference (FIG. 10b), according to embodiments of the present invention;

FIG. 11 is a graph showing throughput results for TSL site reuse factor of 4 vs. a reference case with no TSL reuse), according to an embodiment of the present invention;

FIG. 12 is a schematic representation of an example with TSL reuse factor of 3 allowing 4 TSL multislot transmission, according to an embodiment of the present invention;

FIG. 13 is a schematic representation of an adaptive TSL site reuse for an unsynchronized network, according to an embodiment of the present invention;

FIG. 14 is a block diagram of a mobile communication system with a timeslot (TSL) reuse combined with a frequency reuse for a service based interference control (e.g., for the DSR), according to an embodiment of the present invention; and

FIG. 15 is a flow chart demonstrating timeslot reuse combined with a frequency reuse for a service based interference control, according to an embodiment of the present invention.

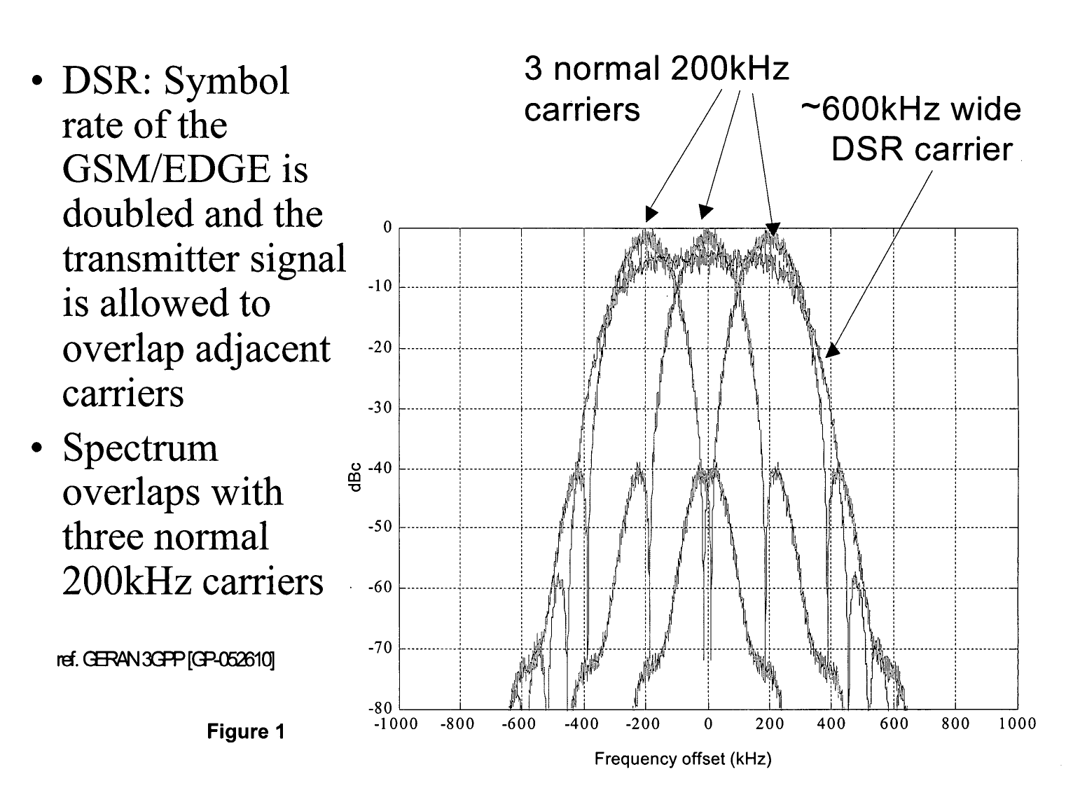

### MODES FOR CARRYING OUT THE INVENTION

A new method, system, apparatus and software product are presented for a timeslot (TSL) reuse typically combined with a frequency reuse for a service based interference control in communication systems (e.g., mobile communication systems). TSL reuse method can be applied to a service with a wider spectrum or a higher symbol rate than for a normal channel bandwidth of a communication system to provide the way for controlling interference. For example, the TSL reuse method can be applied to DSR (dual symbol rate) to provide the way for controlling overlapping DSR interferers. The TSL reuse method can enable interference control for synchronized and unsynchronized networks. The focus of this invention is EGPRS and GERAN evolution but it can be applied to other technologies, like 3.9G or 4G, etc. The TSL reuse method can be applied, for example, to the PS (packet switched) services (e.g., EGPRS) in the networks where the PS and CS (e.g., speech) services use the same frequency resources. The TSL reuse method can be used, e.g., for the PS service to control interference caused by the PS traffic, both in UL (uplink) and DL (downlink).

It is noted the DSR (dual symbol rate) may be also called as “HUGE” for UL and RED-HOT for DL, since both apply higher symbol rate resulting in wider spectrum than for a normal channel bandwidth (e.g., using 200 kHz carriers). Wider transmission spectrum may be also provided by widening the bandwidth of a modulation shaping filter and possibly linked with changing the type of pulse shaping, e.g., from linearised gaussian to root rise cosine. It is also noted that the TSL reuse, according to various embodiments of the present invention, can be applied to a service with a wider spectrum and/or higher symbol rate than normal 200 kHz wide carriers (i.e., than for the normal channel bandwidth) to provide the way for controlling spectral interference.

According to one embodiment of the present invention, the timeslot reuse can be provided only for selected services from predetermined services, which supports the mobile communication system, when the frequency reuse is provided for all predetermined services. But in general, both, the timeslot reuse and/or the frequency reuse can be provided for the all predetermined services or for the selected services.

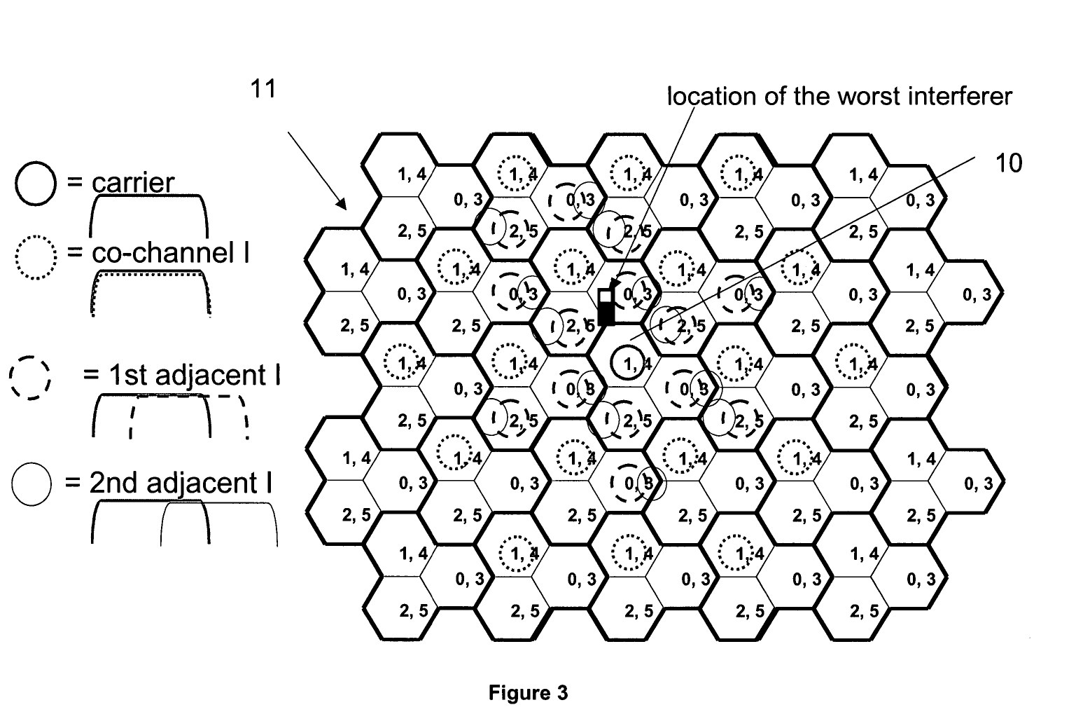

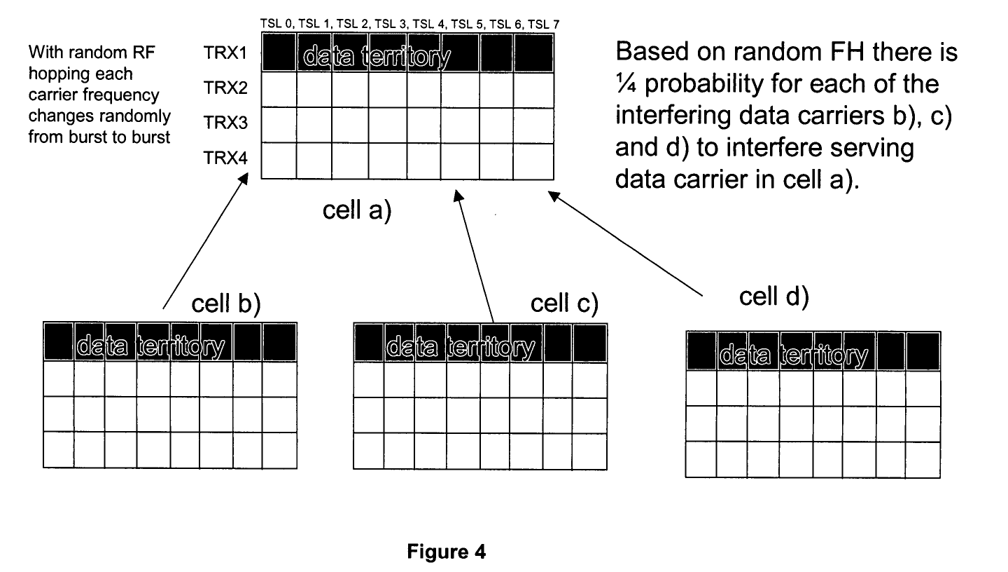

Typically (E)GPRS (enhanced general packet radio service) data territory is generated by reserving consecutive timeslots from a TRX (transceiver) for data traffic (e.g., TRX 1 in FIG. 4) and for speech (e.g., TRXs 2-4 in FIG. 4). In this case data and speech connections are randomly interfering with each other when random FH (frequency hopping) is in use, as shown in FIG. 4. The DSR “brakes” the basic frequency planning with overlapping carriers and thereby interference is randomly received from all cells in case of tight frequency reuse, e.g., using a ratio of 1/3 (as pointed out in FIG. 3). For example, in FIG. 4 there is 1/4 probability for each of the interfering data carriers b), c) and d) to interfere serving data carrier in cell a).

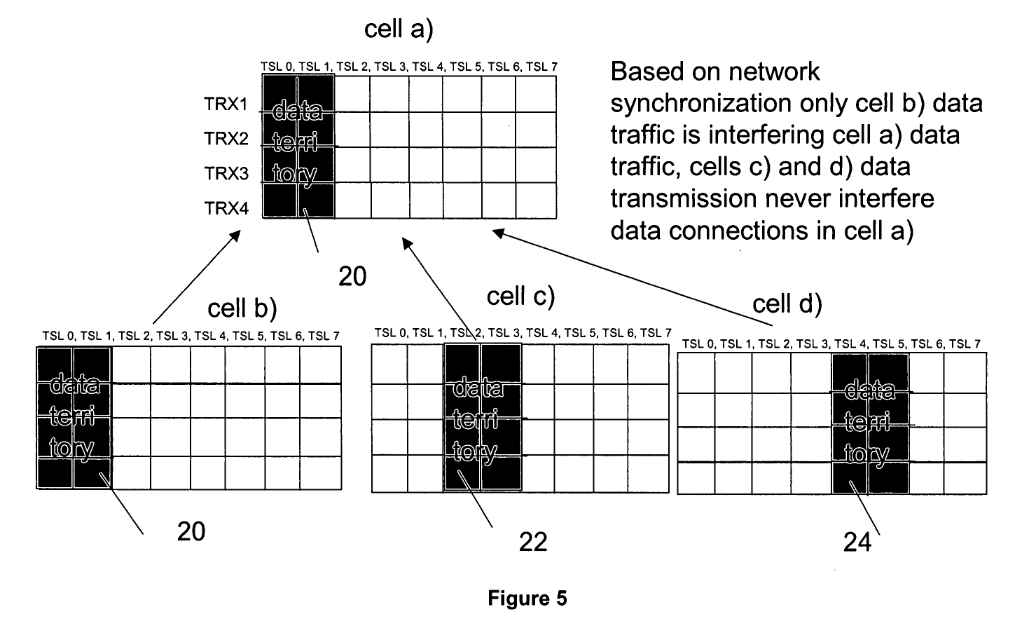

According to an embodiment of the present invention, if only a limited number of timeslots are used for the EGPRS or DSR traffic in certain cells, the EGPRS or DSR interference is then received only from the cells that are using the same timeslots for the EGPRS or DSR traffic, as shown in FIG. 5. As seen in FIG. 5, cells a) and b) use data territory 20 (TSL0 and TSL1), cell c) uses data territory 22 (TSL2 and TSL3) and cell d) uses data territory 24 (TSL4 and TSL5). Thus, only cell b) data traffic is interfering with cell a) data traffic, whereas cell c) and d) data transmission never interfere with data connections in the cell a). This way incoming and outgoing interference can be limited to certain (a smaller number of) cells.

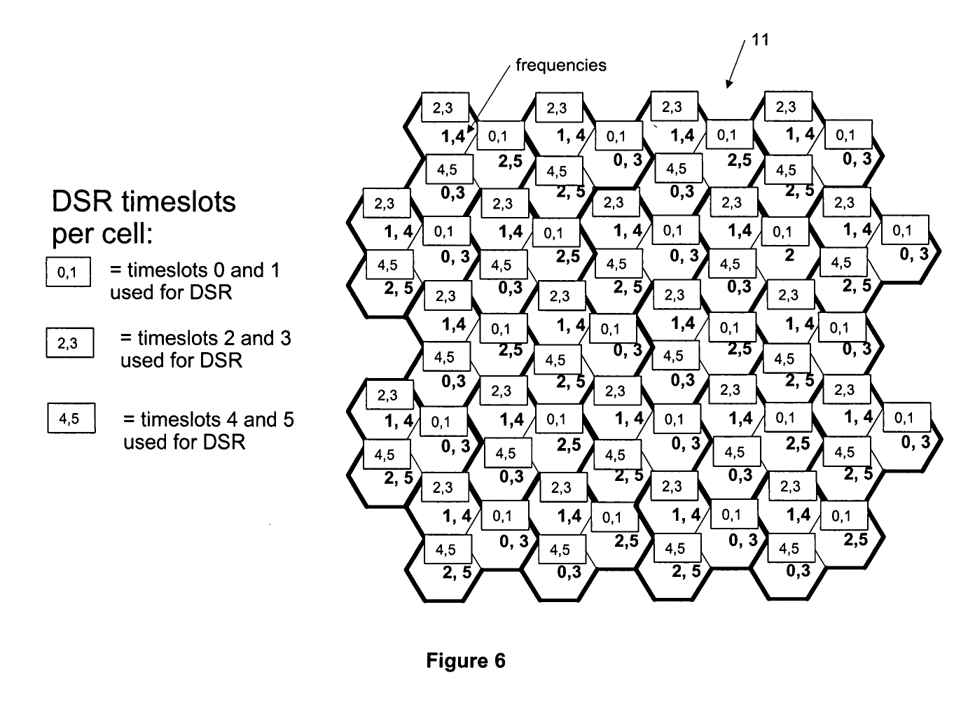

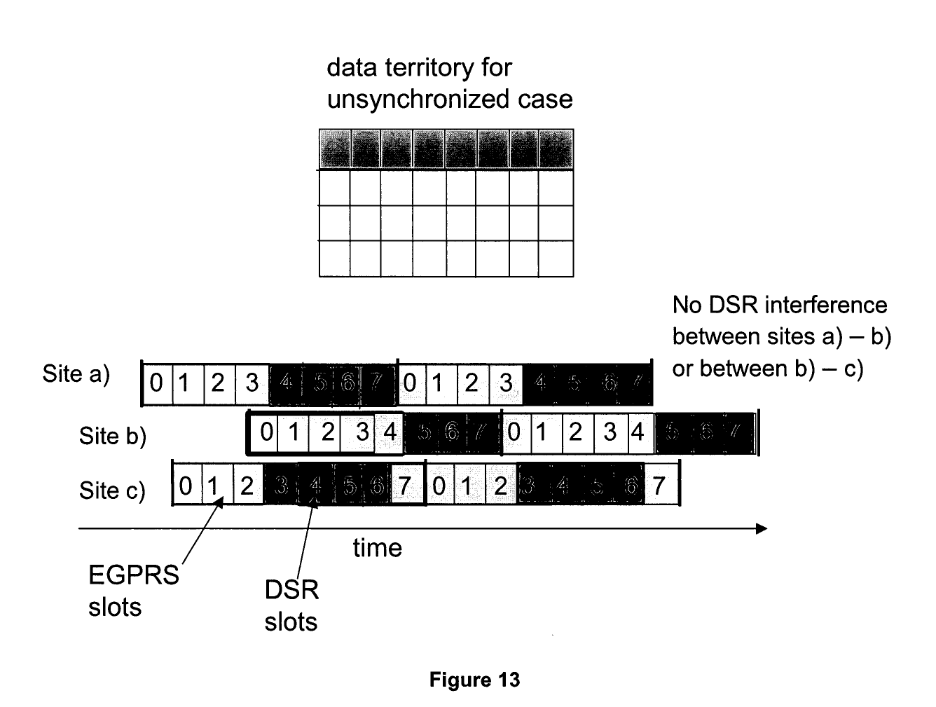

Normally, the GSM system has 8 timeslots. Furthermore, as (E)GPRS supports multi-slot transmission and timeslots for multi-slot transmission need to be consecutive, a typical TSL reuse would then be 2, 3 or 4. In the following examples, TSL cell reuse factor of 3, TSL site reuse factor of 4 and TSL site reuse factor of 3 with partially overlapping data territories configurations have been presented and analyzed as practical examples for synchronized high capacity networks (see FIGS. 6-12). In addition, it is shown how an adaptive TSL reuse can be applied in unsynchronized networks (see FIG. 13).

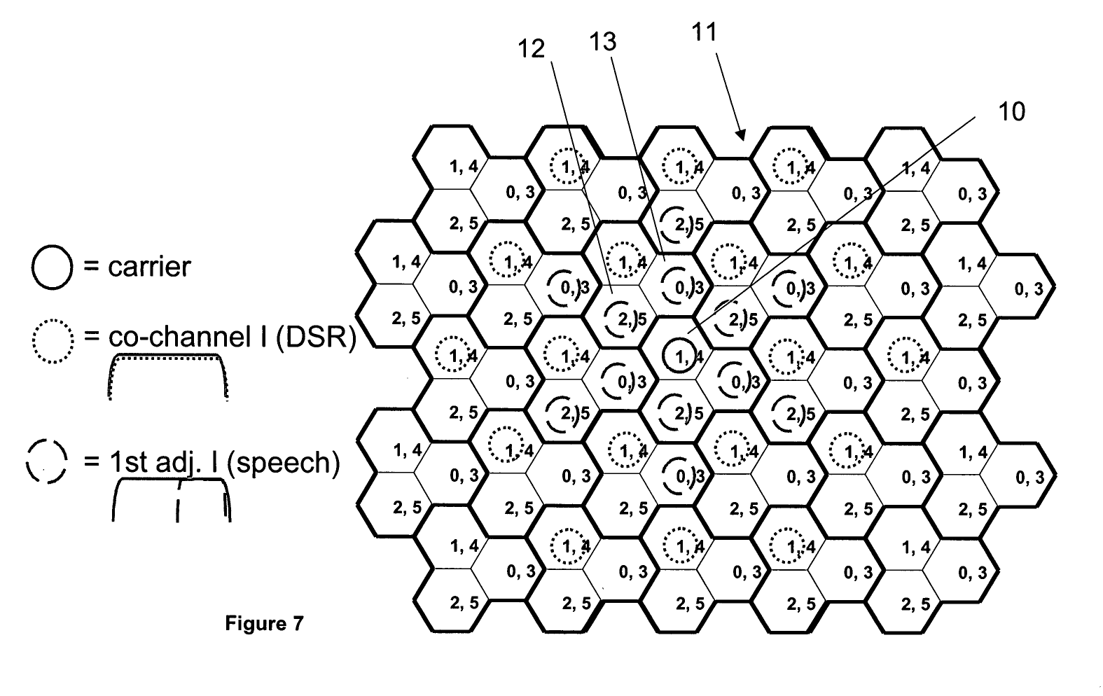

In the FIG. 6 example, according to an embodiment of the present invention, frequency and TSL reuse plans for the case of the TSL cell reuse factor of 3 combined with the 1/3 frequency reuse is presented in the network of cells 11. Timeslot pairs 0 and 1, 2 and 3, and 4 and 5, respectively, mark the cells they are used with. Then, in FIG. 7, locations of the interfering frequencies are shown for the scenario of FIG. 6 and the interference conditions are displayed showing the cells potentially interfering the cell 10 under consideration in the middle of the network of cells 11. By comparing displayed interfering cells between FIGS. 3 and 7 it can be seen how the TSL reuse limits the number of cells from which the DSR interference is received. Then there is more DSR interference from the cells using the same timeslots because those timeslots are fully utilized for the DSR traffic, but the benefit is that the interference is limited to certain (a smaller number of) cells. For example, with the TSL reuse factor of 3, the DSR interference from the worst two cells, cell 12 and cell 13, the closest cells in the antenna main direction, can be avoided.

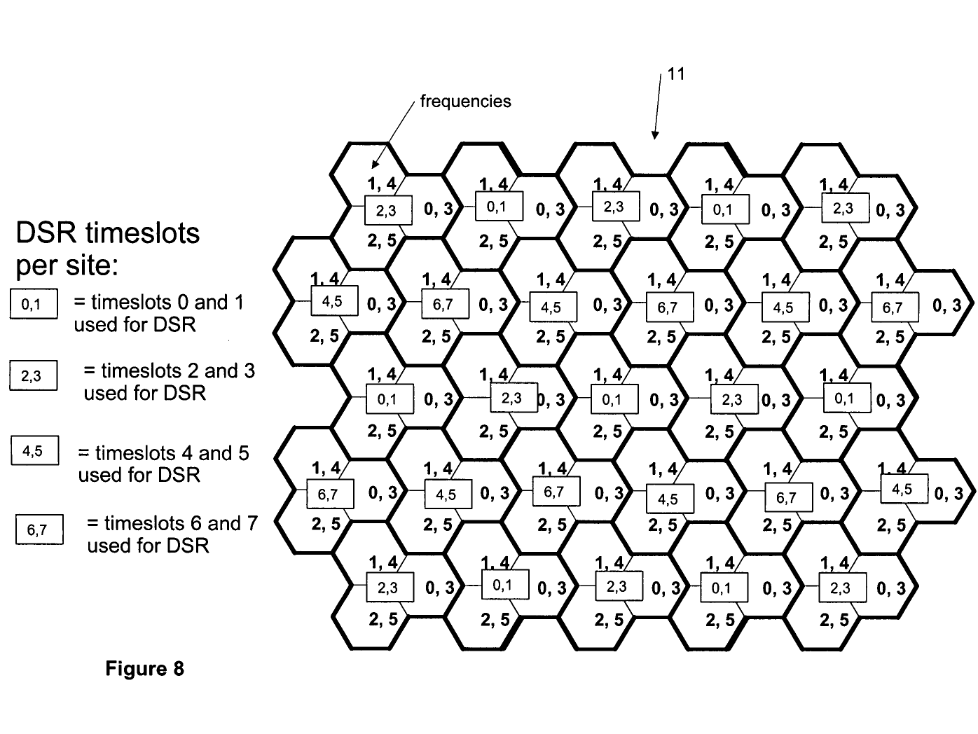

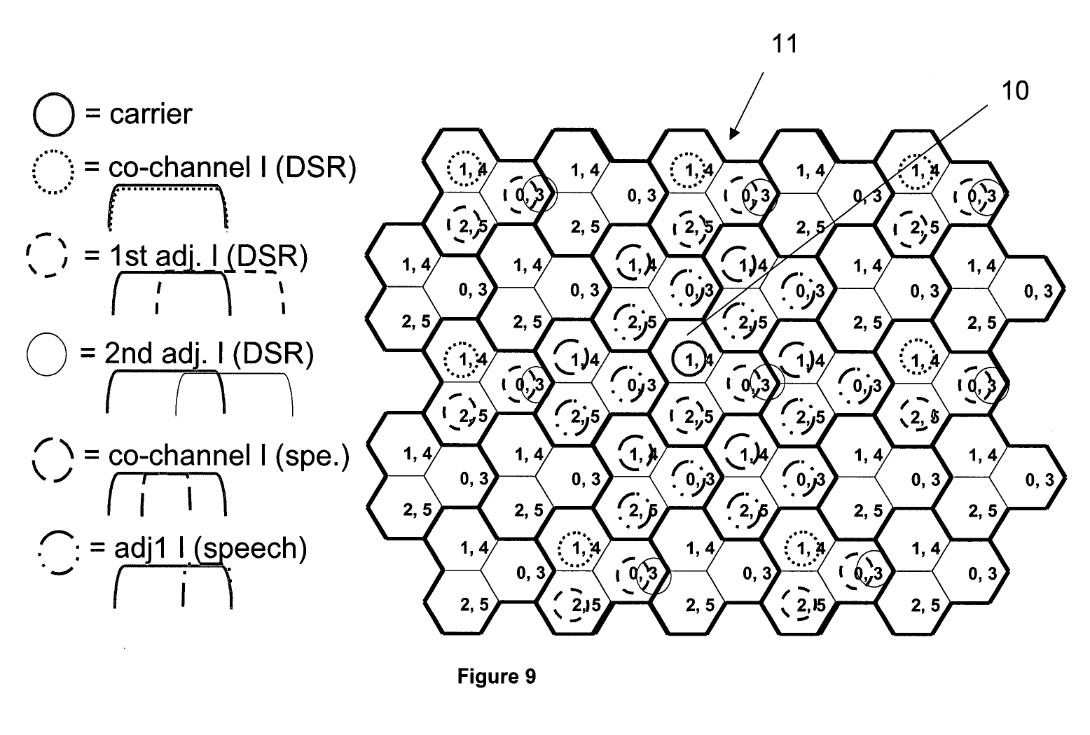

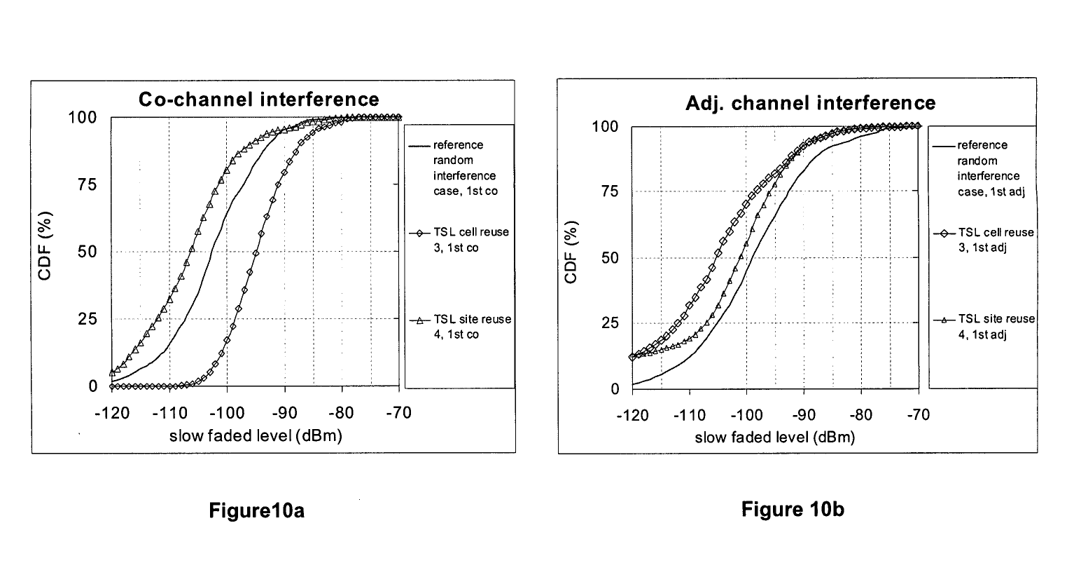

Furthermore, according to an embodiment of the present invention, FIG. 8 presents the case for the TSL site reuse factor of 4 with the 1/3 frequency reuse, and interference conditions of that scenario can be seen in FIG. 9. Timeslot pairs 0 and 1, 2 and 3, 4 and 5 and 6 and 7, respectively, mark the sites they are used with in FIG. 8.

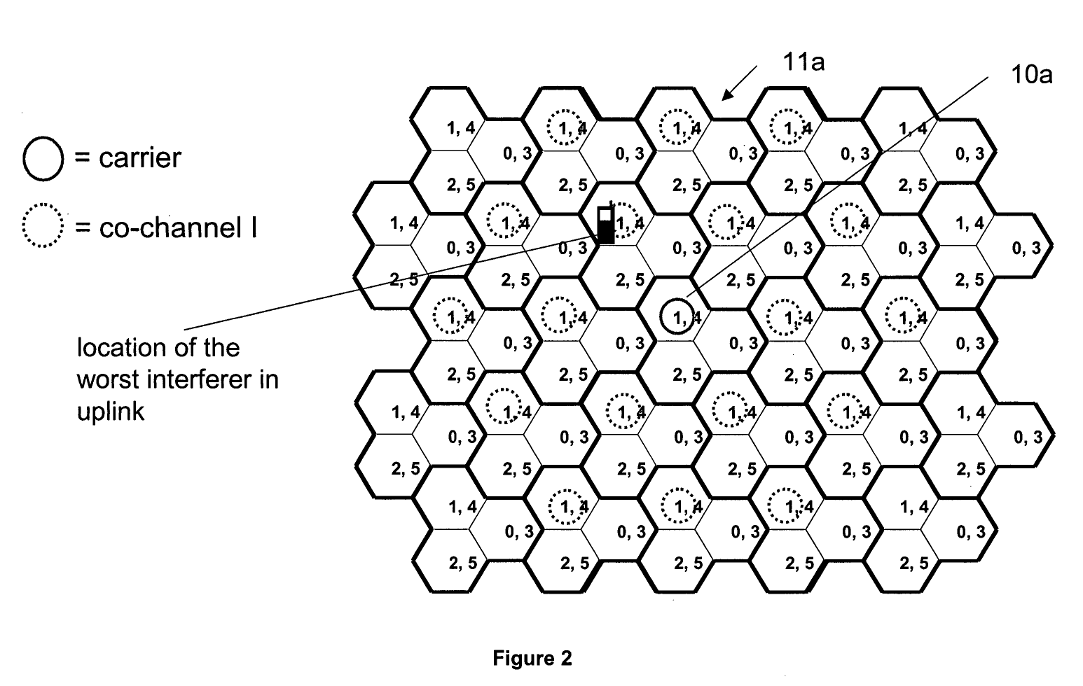

In the case of the TSL cell reuse factor of 3 combined with the 1/3 frequency reuse, the DSR inter-cell interference follows the same pattern as in the basic 1/3 frequency reuse case (compare FIGS. 2 and 7). Then, in the TSL site reuse factor of 4 case, an actual inter-site DSR interference reuse is 12. Note that in the latter case, the DSR interference is received also from its own site.

With both methods (shown in FIGS. 6 and 8), the DSR interference can be controlled much better compared to the reference case because the DSR interference from the worst interfering cells can be totally avoided and the reuse for the DSR interference can be used. The TSL reuse also applies in the interference interaction between the DSR and a speech connection. The speech connection receives the DSR interference only from every third cell.

The interference conditions for the example configurations presented above were studied by recording interference levels from dynamic system level simulations. Statistics from the simulations of CDF (cumulative distribution function) as a function of slow faded level are plotted in FIGS. 10a and 10b for co-channel interference (FIG. 10a) and for adjacent interference (FIG. 10b). A reference random interference case represents the original data territory allocation in which timeslots for the data traffic are allocated consecutively starting from the first TRX. It can be seen in FIG. 10a that the co-channel interference increases with TSL cell reuse factor of 3 planning and decreases with the TSL site reuse factor of 4 planning compared to the reference case. Adjacent channel interference (FIG. 10b) decreases in both cases when the TSL reuse was used. Also note that the second adjacent interference does not occur at all in case of the TSL cell reuse factor of 3 configuration.

Simulation of FIGS. 10a, 10b and 7 demonstrate that using the TSL cell reuse, the DSR interference can be clearly allocated to certain (a smaller number of) cells, preferably to co-channel cells so that the planned interference situation applies also in the case of the DSR traffic (i.e., the interfering cells are the same as the co-channel interfering cells in the original frequency planning for the 200 kHz wide carriers). In the TSL site reuse case it was shown that both co-channel and adjacent channel interference levels are lower compared to the reference case. Thus, the TSL site reuse is an effective method for the overall system level interference control.

Impacts for speech connections were also studied. With the TSL cell reuse planning, speech traffic receives lower co-channel interference levels (because there is no DSR interference at the co-channel), and about the same adjacent channel interference compared to the mixed random interference case. In the TSL site reuse case, there was not much difference at either co-channel or adjacent channel interference levels compared to the reference case.

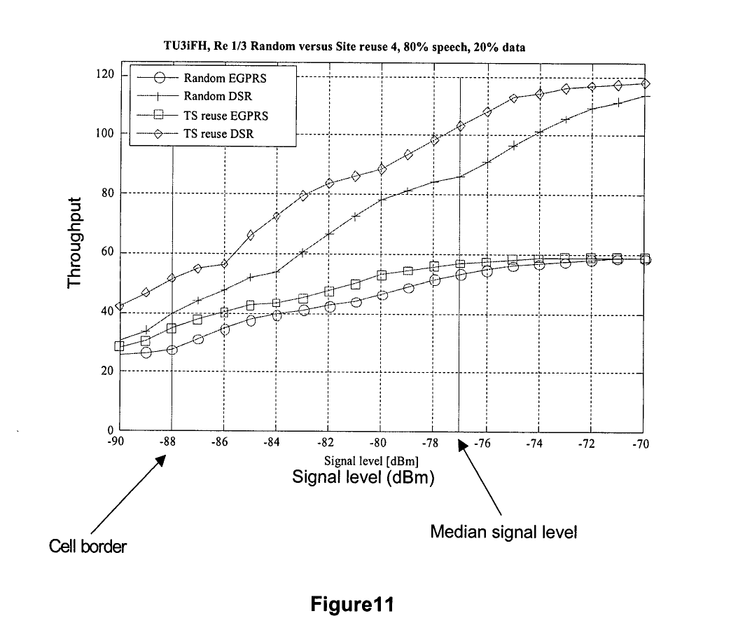

Examples of the link level throughput were evaluated with a link level simulator by importing exact burst-wise interference information from a system simulation to the link level simulator. This method has been used for the DSR performance evaluation in the feasibility study (see GP-052610 referenced above) where the method is also described in more detail. Examples of the throughput simulated results (dependence on the signal level) for the TSL site reuse factor of 4 are shown in FIG. 11. From the system performance point of view, the case of the TSL site reuse factor of 4 showed gain at the regular hexagonal network layout that is typically used in network simulations (about 3 dB gain all over the cell area), as shown in FIG. 11. At the same time, it was found out that speech quality was slightly improved in the network (studied scenario was 20% data traffic and 80% AMR speech traffic). A clear gain was also seen for the basic EGPRS throughput: about 2 dB at the cell edge (FIG. 11). The impact on speech performance was also significant as speech performance improved by about 1 dB at 1% FER. As stated above, the interference levels for speech connections were about the same for the reference and the DSR site reuse case. Better performance in the TSL site reuse case can be explained with increased DIR (dominant-to-rest interference ratio) values that improves IRC (interference rejection combining) performance.

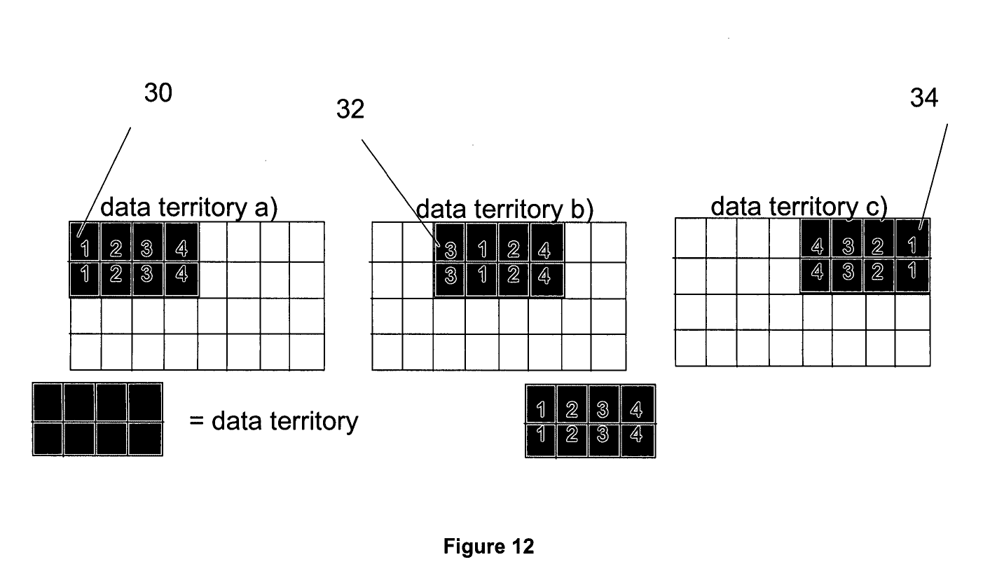

Presented examples of using the TSL cell reuse factor of 3 and the TSL site reuse factor of 4 fit very well to typical 3-sectorized BTSs (base transceiver stations). In FIG. 12, an example of the TSL reuse planning supporting 4 slots multi-slot transmission is presented. In this case, data territories 30 (data territory a), 32 (data territory b), and 34 (data territory c), are partially overlapping (i.e., the data territory b partially overlaps with the data territories a and c), but interference between overlapping slots can be minimized by having allocation priority for the data timeslots (naturally this cannot be done for 4 multi-slot transmission but it is assumed that the 4 slot transmission is very rare in the UL). When the data load is less than 100% traffic, the interference is lower in slots marked with higher numbers as shown in FIG. 12. Another option for interference control is quality based sorting (e.g., used transmit power) of the connections inside the data territory so that less interfering connections are allocated to slots marked with 3 and 4 shown in FIG. 12. This way the interference in the overlapping slots can be minimized.

The TLS reuse method allows DSR interference control also in unsynchronized networks. In the unsynchronized case, the TSL reuse can be used with adaptive TSL site reuse strategy. Sectors inside a site are synchronized so that a good IRC (interference rejection combining) performance against intra-site interference is achieved, thus, overlapping the DSR carriers can be allowed inside the site. For example, for the inter-site TSL reuse definition (i.e., inter-site DSR interference control), the BTS can measure UL interference and estimate the timeslots where the DSR to be used in the closest high interfering cells. Adaptive TSL site reuse idea is presented in FIG. 13. Using the original data territory allocation (consecutive timeslots) 36, the DSR territory is adaptively defined inside the data territory 36, and the rest of the timeslots are used for basic EGPRS. For example, in FIG. 13, there is no DSR interference between sites a) and b) and between b) and c). Then, high bit-rate services are allocated into the DSR timeslots and lower bit-rate services are allocated for the EGPRS timeslots. It is noted that the timeslot reuse “updating” procedure described for the unsynchronized networks can be applied to the synchronized networks as well, if necessary.

It is further noted that according to further embodiments of the present invention the timeslot reuse can be used only for a data service or it can be used only for a packet switched service or it can be used for both the data service and the packet switched service. For example, the frequency reuse can be used for both a circuit switched speech service and for a packet switched data service, whereas the timeslot reuse can be used, e.g., for the circuit switched speech service only. Finally, the timeslot can be used for the services comprising at least one of the following characteristics: a) unequal bandwidths, and b) unequal modulation frequencies.

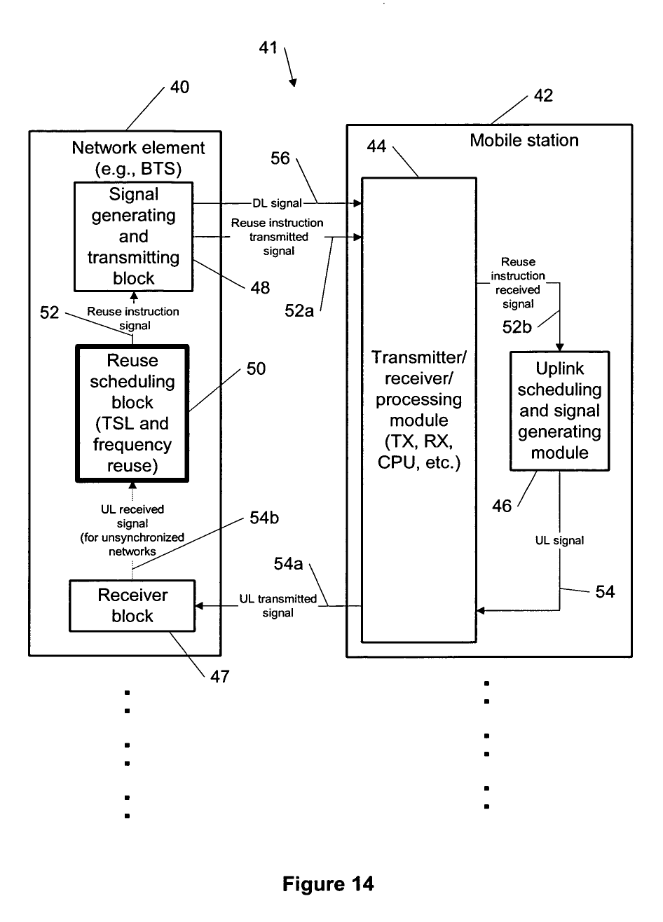

FIG. 14 is an example among others of a block diagram of a mobile communication system 41 for a timeslot (TSL) reuse combined with a frequency reuse for a service based interference control (e.g., for the DSR) in a mobile communication system, according to an embodiment of the present invention. The mobile station (or the user equipment) 42 can be a wireless communication device, a portable device, a mobile communication device, a mobile phone, a mobile camera phone, etc.

In the example of FIG. 14, the mobile station 42 comprises an uplink scheduling and signal generating module 46 and a transmitter/receiver/processing module 44. In the context of the present invention, the mobile station 42 can be a wireless communication device, a portable device, a mobile communication device, a mobile phone, a mobile camera phone, etc. In the example of FIG. 14, the network element 40 (e.g., a BTS) can comprise a signal generating and transmitter block 48, a reuse scheduling block 50 and a receiver block 47.

According to an embodiment of the present invention, the network, e.g., the reuse scheduling block 50, can provide reuse instructions for both TSL and frequency reuse (see signal 52). In case of the downlink (DL), these instructions are provided to the block 48 which generates and sends a DL signal 56 (e.g., comprising data and/or voice information) to the mobile station 42. The uplink (UL) reuse instructions (generally for both TSL and frequency reuse) contained in the signal 52 are forwarded (signal 52a) to the block 44 of the mobile station 42 and then further forwarded (signal 52b) to the block 46. The block 46 uses the uplink reuse instructions contained in the signal 52b for generating an UL signal 54 (e.g., comprising data and/or voice information) which is forwarded by the block 44 (signal 54a) to the receiver block 47 of the network element 40. In the case of unsynchronized networks, the signal 54a is further forwarded by the block 47 to the block 50 which can use (as described in regard to FIG. 13) the signal 54b for providing the reuse instructions (the signal 52).

According to an embodiment of the present invention, the module 50 (the same is applicable to the blocks 44 and 46) can be implemented as a software, a hardware block or a combination thereof. Furthermore, each of the blocks 50, 44 or 46 can be implemented as a separate block or can be combined with any other standard block of the mobile station 42 or the network element 40, or it can be split into several blocks according to their functionality. The transmitter/receiver/processing block 44 can be implemented in a plurality of ways and typically can include a transmitter, a receiver, a CPU, etc. The module 44 provides an effective communication of the module 46 with the network element 40.

In the example of FIG. 14, a network element 40 can be, e.g., a Node B, BTS (base transceiver station), etc. It is noted that the network element 40, for the purposes of describing of various embodiments of the present invention, can be broadly interpreted such that the network element 40 can comprise features attributed to both the Node B or the BTS and a radio network controller (RNC) or a BSC (base station controller). In a typical scenario, the timeslot reuse (and frequency reuse) for cells are predetermined (i.e., preset) and provided to the Node B or the BTS by the RNC or by the BSC, respectively. However, in case of an adaptive timeslot reuse (e.g., for unsynchronized networks), the timeslot reuse can be varied based on the uplink signal measurements by the Node B or the BTS, but the control may still come from the RNC or the BSC. Specifically, the module 50 can be located in the RNC or the BSC (then the signaling from the RNC or the BSC is forwarded to the user equipment by the Node B or by the BTS) or in the Node B or the BTS as shown in FIG. 14, whereas the receiver block 47 is located in the Node B or the BTS.

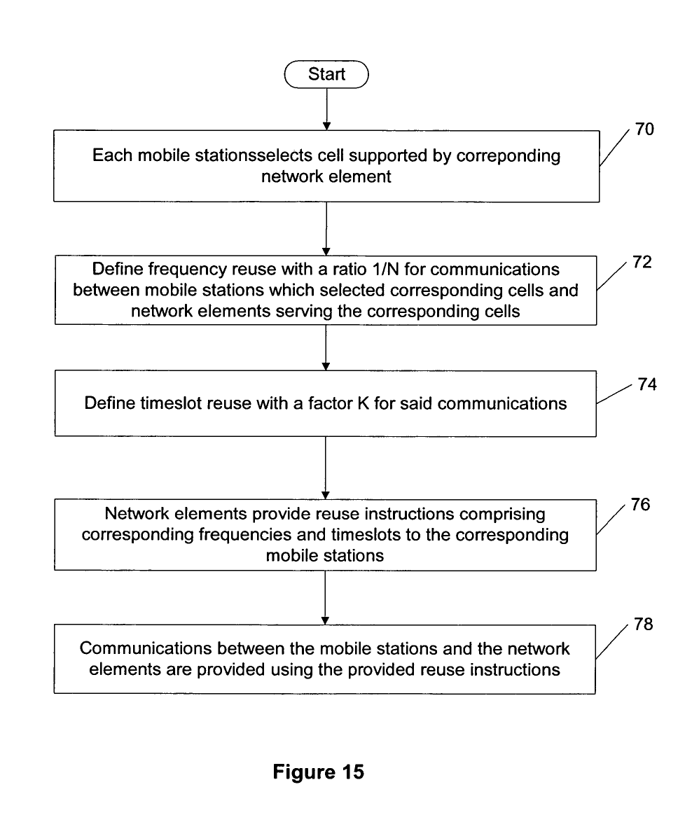

FIG. 15 is an example among others a flow chart demonstrating timeslot reuse combined with a frequency reuse for a service based interference control, according to an embodiment of the present invention.

The flow chart of FIG. 15 only represents one possible scenario among others. The order of steps shown in FIG. 15 is not absolutely required, so generally, the various steps can be performed out of order. In a method according to an embodiment of the present invention, in a first step 70, each mobile station (e.g., the mobile station 42) selects a cell supported by a corresponding network element (e.g., the network element 40).

In a next step 72, the frequency reuse with a ratio 1/N (N being an integer of at least a value of one) for communications between mobile stations which selected corresponding cells and network elements serving the corresponding cells is defined. It is noted that the frequency reuse is broadly defined for the purpose of describing various embodiments of the present invention, wherein the frequency reuse with N=1 (i.e., the frequency reuse ratio is equal to one) is possible for a situation, e.g., in the GSM networks using MAIO (mobile allocation index offset) management, wherein the frequency reuse 1/1 can be used in such a way that all frequencies are used in all cells, but hopping is managed so that adjacent sectors/cells are not using the same frequency at the same time.

In a next step 74, the timeslot reuse with a factor K (K being integer of at least a value of two) for said communications. In a next step 76, the network elements provide reuse instructions comprising corresponding frequencies and timeslots to the corresponding mobile stations. In a next step 78, the communication between the mobile stations and the network elements are provided using the provided reuse instructions.

As explained above, the invention provides both a method and corresponding equipment consisting of various modules providing the functionality for performing the steps of the method. The modules may be implemented as hardware, or may be implemented as software or firmware for execution by a computer processor. In particular, in the case of firmware or software, the invention can be provided as a computer program product including a computer readable storage structure embodying computer program code (i.e., the software or firmware) thereon for execution by the computer processor.

It is noted that various embodiments of the present invention recited herein can be used separately, combined or selectively combined for specific applications.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method, comprising:
providing a frequency reuse with a ratio 1/N for communications between mobile stations which selected corresponding cells and network elements serving said corresponding cells in a communication system, N being an integer of at least a value of one; and
further providing a timeslot reuse with a factor K for said communications, K being an integer of at least a value of two.

2. The method of claim 1, wherein said timeslot reuse is provided only for selected services out of predetermined services which support the communication system.

3. The method of claim 2, wherein said frequency reuse is provided for said all predetermined services.

4. The method of claim 1, wherein the timeslot reuse is provided only for a data service or only for a packet switched service.

5. The method of claim 1, wherein the frequency reuse is provided for both a circuit switched speech service and for a packet switched data service and wherein the timeslot reuse is provided for the circuit switched speech service only.

6. The method of claim 1, wherein the timeslot reuse is provided for services comprising at least one of the following characteristics:
b) unequal bandwidths, and
c) unequal modulation frequencies.

7. The method of claim 1, wherein the timeslot reuse is provided for at least one of the following services:
a) a dual symbol rate service,
b) an enhanced general packet radio service,
c) a service with a wider spectrum than a normal channel bandwidth, and
d) a service with a higher symbol rate than for a normal channel bandwidth.

8. The method of claim 1, wherein said timeslot reuse is a cell timeslot reuse or a site timeslot reuse.

9. The method of claim 1, wherein said communication between the mobile stations and the network elements are performed within unsynchronized networks.

10. The method of claim 1, wherein said communications between the mobile stations and the network elements are performed within evolved global system for mobile communications/enhances data rates for global evolution radio access network.

11. The method of claim 1, wherein said communications between the mobile stations and the network elements are performed in an uplink.

12. The method of claim 1, wherein said communication between the mobile stations and the network elements are performed within time division multiple access based networks.

13. The method of claim 1, wherein said network element is a base transceiver station configured for wireless communications.

14. A computer program product comprising: a computer readable storage structure embodying computer program code thereon for execution by a computer processor with said computer program code, wherein said computer program code comprises instructions for performing the method of claim 1, indicated as being performed by any component or a combination of components of said communication system.

15. A network element, comprising:
a reuse scheduling block, for providing to a mobile station reuse instructions comprising a frequency and a timeslot for communicating between the mobile station and the network element in a communication system, wherein said frequency is defined using a frequency reuse with a ratio 1/N for communications between mobile stations which selected corresponding cells and network elements serving said corresponding cells in said communication system, N being an integer of at least a value of one, and said timeslot is defined using a timeslot reuse with a factor K for said communications, K being an integer of at least a value of two, and wherein said timeslot reuse is provided only for selected services out of predetermined services which support the communication system; and
a signal generating and transmitting module, for said communicating with said mobile station.

16. The network element of claim 15, wherein said signal generating and transmitting module is for transmitting said reuse instructions to said mobile station.

17. The network element of claim 15, wherein said timeslot reuse improves interference control in the communication system.

18. The network element of claim 17, wherein said timeslot reuse is provided only for selected services out of predetermined services which support the communication system.

19. The network element of claim 15, wherein said frequency reuse is provided for said all predetermined services.

20. The network element of claim 15, wherein the timeslot reuse is provided only for a data service or only for a packet switched service.

21. The network element of claim 15, wherein the frequency reuse is provided for both a circuit switched speech service and for a packet switched data service and wherein the timeslot reuse is provided for the circuit switched speech service only.

22. The network element of claim 15, wherein the timeslot reuse is provided for the services comprising at least one of the following characteristics:
d) unequal bandwidths, and
e) unequal modulation frequencies.

23. The network element of claim 15, wherein the timeslot reuse is provided for at least one of the following services:
a) a dual symbol rate service,
b) an enhanced general packet radio service,
c) a service with a wider spectrum than a normal channel bandwidth, and
d) a service with a higher symbol rate than for a normal channel bandwidth.

24. The network element of claim 15, wherein said communicating between the mobile station and the network element is performed in an uplink.

25. The network element of claim 15, wherein said timeslot reuse is a cell timeslot reuse or a site timeslot reuse.

26. The network element of claim 15, wherein said communicating between the mobile station and the network element is performed within time division multiple access based networks.

27. The network element of claim 15, wherein said communicating between the mobile station and the network element is performed within unsynchronized networks and the reuse scheduling block is responsive to an uplink signal comprising data or voice information.

28. A communication system, comprising:
mobile stations which selected corresponding cells; and
network elements serving said corresponding cells, for providing to the mobile stations reuse instructions comprising corresponding frequencies and timeslots for communications between the corresponding mobile stations and the network elements, wherein said corresponding frequencies are defined using a frequency reuse with a ratio 1/N applied to said communications, N being an integer of at least a value of one, and said timeslots are defined using a timeslot reuse with a factor K for said communications, K being an integer of at least a value of two.

29. The communication system of claim 28, wherein the timeslot reuse is provided only for one of: a) a data service, b) a packet switched service, and c) selected services out of predetermined services which support the communication system.

30. The communication system of claim 28, wherein the timeslot reuse is provided for at least one of the following services:
a) a dual symbol rate service,
b) an enhanced general packet radio service,
c) a service with a wider spectrum than a normal channel bandwidth, and
d) a service with a higher symbol rate than for a normal channel bandwidth.

31. A mobile station, comprising:
an uplink scheduling and signal generating module, responsive to reuse instructions comprising a frequency and a timeslot for communicating between the mobile station and a network element in a communication system, wherein said frequency is defined using a frequency reuse with a ratio 1/N for communications between mobile stations which selected corresponding cells and network elements serving said corresponding cells in said communication system, N being an integer of at least a value of one, and said timeslot is defined using a timeslot reuse with a factor K for said communications, K being an integer of at least a value of two out of predetermined services which support the communication system; and
a transmitter/receiver processing module, for receiving a reuse instruction signal comprising said reuse instructions and for providing said reuse instructions signal to said uplink scheduling and signal generating module, and for providing said communicating between said network element and said mobile station.

32. The mobile station of claim 31, wherein said timeslot reuse improves interference control in the communication system.

33. The mobile station of claim 31, wherein said timeslot reuse is provided only for selected services out of predetermined services which support the communication system.

34. A network element, comprising:
scheduling means, for providing to a mobile station reuse instructions comprising a frequency and a timeslot for communicating between the mobile station and the network element in a communication system, wherein said frequency is defined using a frequency reuse with a ratio 1/N for communications between mobile stations which selected corresponding cells and network elements serving said corresponding cells in said communication system, N being an integer of at least a value of one, and said timeslot is defined using a timeslot reuse with a factor K for said communications, K being an integer of at least a value of two; and
receiving and generating means, for communicating with said mobile station.

35. A network element of claim 34, wherein the scheduling means is a reuse and scheduling block, and said receiving and generating means is a signal generating and transmitting module.
